(19) United States
(12) Patent Application Publication
(10) Pub. No.: US 2026/0142720 A1
(43) Pub. Date: May 21, 2026

(54) Determinsticly Parsable Reportiong of Radio Access Network Radio Unit Performance Information

(71) Applicant: Rakuten Symphony. Inc., Tokyo (JP)

(72) Inventors: Somashekar Mudaraddi, Bangalore, Karnataka (IN); PankajKumar Rathore, Bangalore, Karnataka (IN); Sridhar Bhaskaran, Bangalore, Karnataka (IN); Virendra Reddy, Bangalore, Karnataka (IN)

(21) Appl. No.: 18/683,421

(22) PCT Filed: Dec. 20, 2023
(86) PCT No.: PCT/US2023/085096

§ 371 Date: Feb. 13, 2024

(30) Foreign Application Priority Data
Apr. 14, 2023 (IN) 202341027682

(51) Int. Cl. H04B 10/079; H04B 17/318; H04W 24/10

(52) U.S. Cl. CPC H04B 10/07955; H04B 17/318; H04W 24/10

(57) ABSTRACT

A system includes a cellular communication antenna and a radio unit (RU) coupled to the cellular communication antenna. The RU is configured to retrieve status data of the RU and write a plurality of values of the status data in a file by, for each row of a plurality of rows of the file storing a measurement group and an object unit identifier corresponding to the measurement group, the measurement group and the object unit identifier being assigned to values from the status data stored in each row of the plurality of rows. The RU may then store and/or transmit the file.

### BACKGROUND

### Cross-Reference to Related Application

This application claims the benefit of Indian Application Serial No. 202341027682, filed Apr. 14, 2023, which is hereby incorporated herein by reference in its entirety.

### Field of the Invention

This invention relates to deterministically parsable reporting of radio access network radio unit performance information.

### Background of the Invention

An open radio access network (O-RAN) includes radio units (RU) that are coupled to one or more antennas for transmitting and receiving wireless signal with respect to user equipment (UE), such as mobile phones. Each RU is coupled to a distributed unit (DU), which itself may be coupled to a central unit along with a plurality of other DUs. An orchestrator, such as a service management and orchestration (SMO) according to the O-RAN standard, may receive status information from the RUs in order to monitor operation of the RUs.

### SUMMARY OF THE INVENTION

In one aspect of the invention, a system comprises a cellular communication antenna and a radio unit (RU) coupled to the cellular communication antenna. The RU is configured to retrieve status data of the RU and write a plurality of values of the status data in a file by, for each row of a plurality of rows of the file storing a measurement group and an object unit identifier corresponding to the measurement group, the measurement group and the object unit identifier being assigned to values from the status data stored in each row of the plurality of rows. The RU may then store and/or transmit the file.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a schematic block diagram illustrating a cellular communication network;

FIG. 2 is a schematic block diagram of a radio unit;

FIG. 3 is a process flow diagram of a method for generating a file reporting radio unit status information in accordance with an embodiment of the present invention;

FIG. 4 is a table showing the arrangement of data within a file reporting radio unit status information in accordance with an embodiment of the present invention;

FIG. 5 is a process flow diagram of a method for writing values in the file with a fixed number of columns;

FIG. 6 is a process flow diagram of a method for reading values in a file with a fixed number of columns; and

FIG. 7 is a schematic block diagram of an example computing device suitable for implementing methods in accordance with embodiments according to the disclosure.

### DETAILED DESCRIPTION

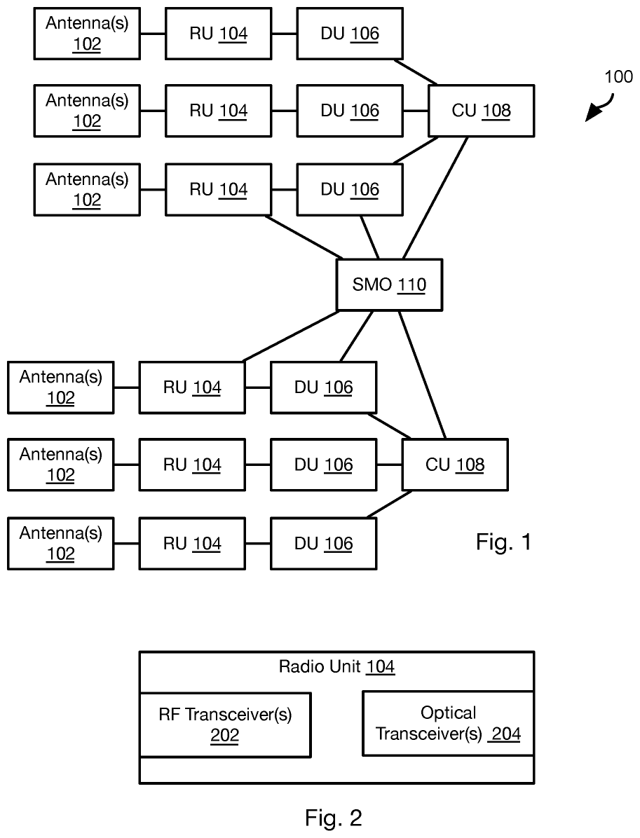

FIG. 1 illustrates an example cellular communication network 100. The cellular communication network 100 includes a plurality of antennas 102 capable of transmitting and receiving cellular radio signals. The antennas 102 may be beam-forming antennas, directional antennas, or any type of antennas known in the art of cellular radio communication. The antennas 102 may include power amplifiers or other signal-processing electronics.

One or more antennas 102 are coupled to a radio unit (RU) 104. The radio unit may include electronic components configured to translate binary data to be transmitted into signals to be transmitted by the one or more antennas 102. Likewise, the RU 104 translates signals received from the one or more antennas 102 into binary data.

One or more radio units 104 are coupled to a distributed unit (DU) 106. Each DU 106 may be implemented as a computing device configured to receive binary data from the RUs 104 and route the binary data over a network connection to a central unit (CU 108) or other DU 106. Likewise, each DU may receive data over the network from the CU 108 or another DU 106 and transmit the data to the one or more RUs 104 for transmission.

An orchestrator, such as a service management and orchestration orchestrator (SMO) 110 according to the O-RAN standard, monitors the status of the network 100. For example, the SMO 110 may communicate with the RUs 104 to monitor the status of the RUs 104. The SMOs 110 may be coupled to the RUs 104 directly by a network connection or communication with the RUs 104 by way of a DU 106 connected to the RU 104 and possibly a CU connected to the DU 106.

Each RU 104, DU 106, CU 108, and the SMO 110 may be implemented according to the O-RAN. The O-RAN standard may be as published by the O-RAN alliance in the following documents, all of which are incorporated herein by reference in their entirety:
O-RAN Architecture Description 9.0, O-RAN.WG1.OAD-R003-v09.00 (June 2023).

O-RAN Slicing Architecture 10.0, O-RAN.WG1.Slicing-Architecture-R003-v10.00 (June 2023).

O-RAN Use Cases Analysis Report 11.0, O-RAN.WG1.Use-Cases-Analysis-Report-R003-v11.00 (June 2023).

O-RAN Use Cases Detailed Specification 11.0, O-RAN.WG1.Use-Cases-Detailed-Specification-R003-v11.00 (June 2023).

O-RAN R1 interface: Use Cases and Requirements 4.0, O-RAN.WG2.R1UCR. v04.00 (June 2023).

O-RAN Massive MIMO Use Cases Technical Report 1.0, O-RAN.WG1.mMIMO-Use-Cases-TR-v01.00 (June 2022).

Referring to FIG. 2, each RU 104 may include various electronics. For example, the RU 104 may include a radio frequency (RF) transceiver 202 configured to transmit and receive RF signals with respect to the one or more antennas 102 coupled to the RU 104. The antennas 102 and associated electronics may amplify and transmit RF signals received from the RU 104.

RU 104 may further include an optical transceiver 204. The optical transceiver 204 may be coupled to an optical fiber connecting the RU 104 to a DU 106 or other computing device. The optical transceiver 204 converts binary data into optical signals transmitted over the optical fiber and converts optical signals received over the optical fiber into binary data. The optical transceiver 204 may be implemented as a small form-factor pluggable (SFP) transceiver, SFP28 transceiver, quad small form-factor transceiver (QSFP), QSFP+, QSFP28, QSFP56, or XFP transceiver. The optical transceiver 204 may include one or more sensors and may report, or facilitate the measurement of, various items of status data. The outputs of the one or more sensors and the various items of status data may be transmitted by the RU 104 to the SMO 110 to enable the SMO 110 to assess the status of the network 100.

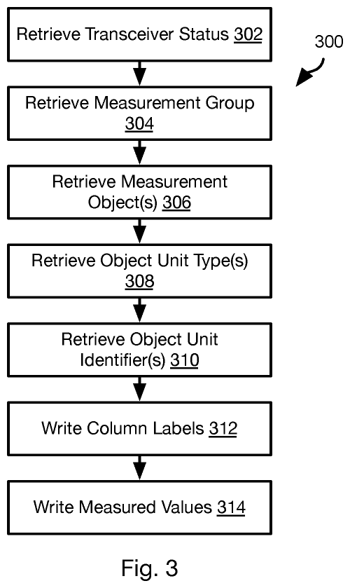

FIG. 3 illustrates a method 300 for generating a file containing status data of an RU 104. The method 300, and other methods disclosed herein, presume data reported by an RU 104 with respect to an optical transceiver 204 with the understanding that any other type of data describing the state of operation of the RU 104 may be processed in a like manner. The method 300 may be performed with respect to a time period (“the current time period”) having a start time (e.g., the end time of a preceding time period) and an end time

The method 300 includes retrieving 302 a status of the optical transceiver 204. Retrieving the status may include retrieving data from registers of the RU 104, such as performance management (PM) counters of the RU 104. Retrieving 302 the status may include retrieving measured values of physical properties such as some or all of:
a temperature for the time period, e.g., maximum, minimum, average or other statistic for temperature measurements of a temperature sensor of the optical transceiver 204 during the time period.
A received power for the time period, e.g., maximum, minimum, average or other statistic for optical signals received by the optical transceiver 204 during the time period. Received power may be for a particular lane.
A transmitted power for the time period, e.g., maximum, minimum, average, first, last, or other statistic for optical signals transmitted by the optical transceiver 204 during the time period. Transmitted power may be for a particular lane.
Frequency data for the time period, e.g., center frequency, bandwidth (e.g., −3 dB bandwidth), or other information describing the frequency of transmitted optical signals and possibly a statistical characterization (e.g., maximum, minimum, average, first, last, standard deviation) of the center frequency and/or bandwidth during the time period.
Frequency bin count for the time period, e.g., number of occurrences during the time period of frequency being within range corresponding to each bin of a plurality of frequency bins.
Aggregation of any of the above-reference values for multiple ports or multiple transceivers.

The status may include other values describing throughput of the transceiver during the time period, such as data transmitted per unit time, data received per unit time or any other statistical characterization (e.g., maximum, minimum, average, standard deviation) of data transmitted or received during the time period.

The above-described examples of the status of the optical transceiver 204 are exemplary only and any other data describing the operation of the optical transceiver 204 or the RU 104 itself, including with respect to the transmission and receipt of radio frequency signals, may be retrieved at step 302. For example, other values that may be retrieved and processed according to the method 300 may include some or all of the following:
A received signal strength indicator (RSSI) measurements for each frequency band of a plurality of frequency bands and/or a statistical characterization (e.g., maximum, minimum, average, first, last, standard deviation) of the RSSI for each frequency band during the time period.
Frequency upper bound for the time period.
Frequency lower bound for the time period.
Function for the time period.
Voltage for the time period, e.g., a supply voltage and/or a statistical characterization (e.g., maximum, minimum, average, standard deviation).
Energy Power and Environment (EPE) Measurements and Statistics.
Transmit and receive window measurements.
Energy measurements.
Aggregations or Statistics for any of the above-reference values.

The method may include retrieving 304 a measurement group of the RU 104. The measurement group may be an identifier of associating multiple optical transceivers 204 with one another or multiple RUs 104 with one another. The entities (optical transceivers 204 and/or RUs 104) belonging to the measurement group may be related to one another by geographic proximity, hardware similarity (e.g., same model, same manufacturer, etc.), usage similarity (e.g., similar data throughput), or any other logical association deemed relevant by an administrator of the network 100.

The method 300 may include retrieving 306 one or more measurement objects for the measurement group. The measurement objects may include identifiers of a physical property or other parameter that is measured, recorded, or otherwise transmitted by the radio unit as part of the method 300. The measurement objects may include identifiers of any of the items of data included in the transceiver status from step 302.

The method 300 may include retrieving 308 object unit types and retrieving 310 object unit identifiers for each of the measurement objects retrieved at step 306. The object unit types may identify a type of a source of data represented by a measurement object and the object unit identifier identifies the source of the data. The object unit type and object unit identifier may be defined according to the O-RAN WG4 M Plane specification, which is hereby incorporated herein by reference in its entirety. For example, object unit types may specify a level of granularity of values recorded in a row (RU-level,-transport-level, port level). For example, a port-level object type may include a port number with the object unit identifier being the port number itself. In another example, the object unit type may be at the RU level and list a type of radio hardware and the object unit identifier is an identifier of a specific RU 104.

The method 300 may include writing 312 column labels to the file, such as to the file that is otherwise unwritten. Column labels may correspond to the measurement group (e.g., measurement group identifier), measurement object (e.g., measurement object identifier), a start time of the time window (which may also indicate a date), an end time of the time window (which may also indicate a date), an object-unit type, and object unit identifier as defined above. Other column labels may also be written, such as a report information type label, a report information identifier label, and a value label. Column labeled by the report information type label may store values describing the type of data included in the values stored in the column labeled by the value label. For example the value stored in the report information type column may indicate a numerical format (e.g., decimal64 with four fractional digits). The report information identifier label includes an identifier of the specific information being reported in the column labeled by the value label. For example, example values that may be stored in the column labeled by the report information type label may include maximum, minimum, latest, frequency bin, or other value that describes the information stored in the column labeled by the value label.

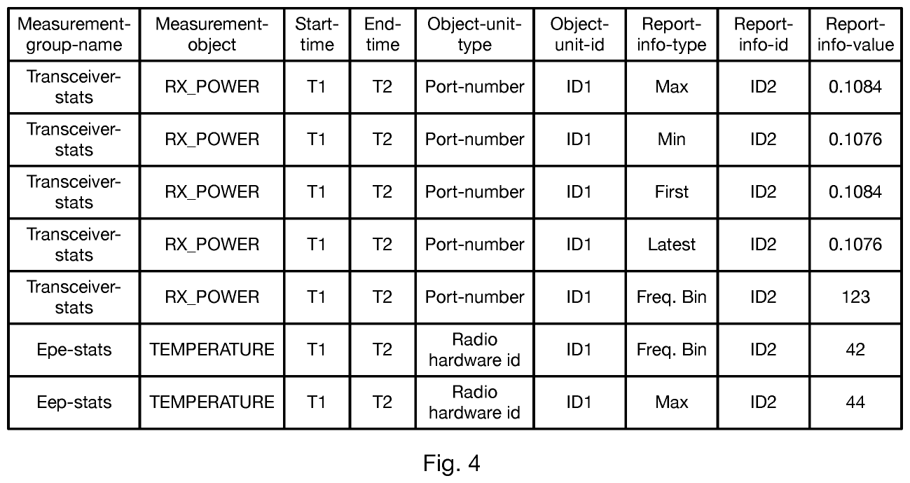

The method 300 may include writing 314 information from steps 302-310 to the file in corresponding columns as labeled at step 312. There may be multiple rows in the file. FIG. 4 illustrates a table that may be generated according to the method 300. The values shown are exemplary only and each row may have unique values relative to other rows. However, in many instances, the value in a particular column may be repeated in multiple rows. For example, multiple rows may represent data for the same time window and therefore have the same start and end time. Multiple rows may list the same values for measurement group, measurement object, object unit type, and object unit identifier. The report information type and report information identifier may be used to identify the specific information stored in the report information value column.

There may be multiple report information value columns. For example, for a physical parameter (received power, transmitted power, temperature, voltage, frequency bin, or any other values referenced herein), the report information values stored in the report information value columns may include some or all of max, min, average, first, last, standard deviation, or other statistical value. For frequency bins, the report information column values may include a frequency bin identifier, the frequency bin count for the frequency bin time period. The report information column values may include multiple sets of frequency bin identifiers and corresponding frequency bin counts for the time period.

Although the format of FIG. 4 results in the duplication of some information, the parsing of the file will be deterministic and correspond to coding best practices, e.g., the Internet Engineering Task Force (IETF) Request for Comment (RFC) 4180, published October 2005, which is hereby incorporated herein by reference. Note that the format of FIG. 4 may be stored as comma separated values (CSV), such that within each row, a comma is positioned between adjacent values. The ordering of the columns in the file may be according to an ordering defined in the NETCONF notification as defined in the O-RAN performance-management module standard or some other ordering. Note, however, that the approach described herein uses a smaller number of octets as compared to the NETZCONF notification.

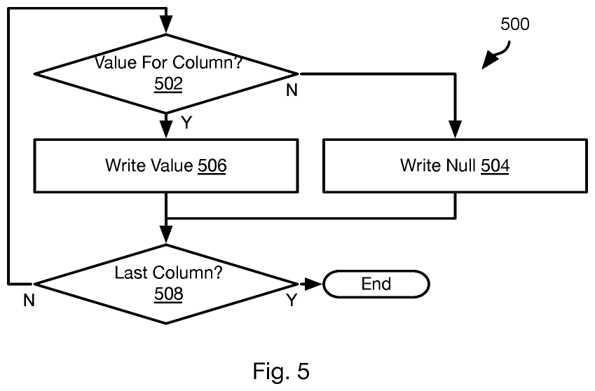

FIG. 4 is one example implementation for a file generated according to the method 300. FIG. 5 illustrates an alternative approach for writing files at steps 312 and 314 of the method 300. In the approach of FIG. 5, a row includes more columns than shown in FIG. 4. Multiple values may be included in each row and each reported value may not have an adjacent value indicating a type or identifier of the reported value. Instead, each column represents a particular reported value. In the approach of FIG. 5, when writing a row, if a column is found 502 to not have a corresponding value, a null value is written 504. If a column is found to have a corresponding value, the value is written 506 to that column. Once the last column is found 508 to have been processed, writing of the row ends. FIG. 5 may be used to write comma separated values (CSV), such that within each row, a comma is positioned between adjacent values. FIG. 5 has the disadvantage of possibly writing many null values but has the advantage of being highly deterministic and readily parsed.

A file generated according to the method 300 and according to the format shown in FIG. 4 or according to the method 500 may be transmitted to a remote computer, such as the DU 106, CU 108, and/or SMO 110. The file may be transmitted using the optical transceiver 204 or using a different device and a physical network connection other than an optical fiber coupled to the optical transceiver 204. The file may be compressed and/or encrypted prior to transmission. Note that null values and repeated values created in order to maintain a fixed number of columns are both readily compressible and therefore their contribution to the size of the files can be significantly reduced.

In yet another approach, the number of columns is not fixed. Instead, each row includes one or more, and possibly a plurality of, attribute-value pairs, each pair including a value label and a value corresponding to the value label, e.g. “temperature, 30.” Accordingly, a parser will read each value label to determine the meaning of an adjacent value and read the adjacent value for each attribute-value pair, until the end of a line is reached.

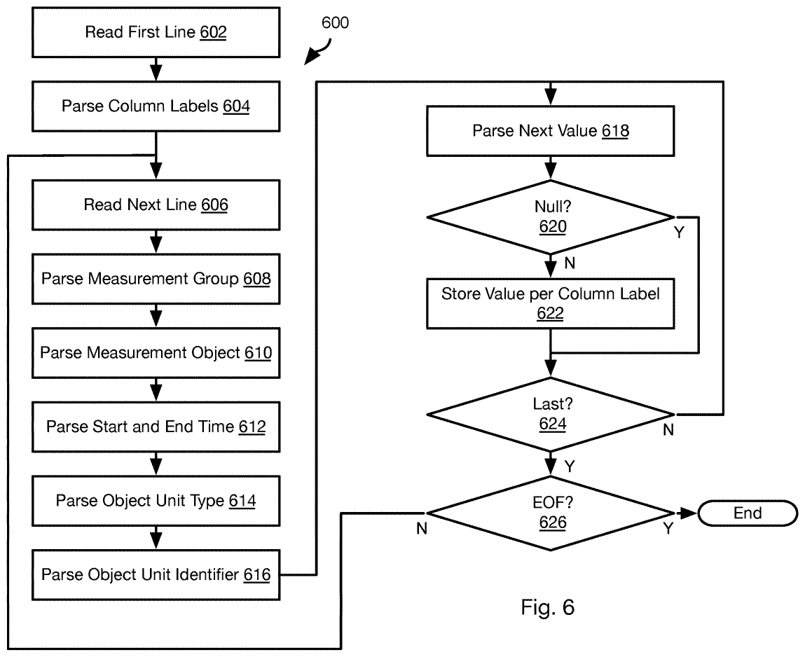

FIG. 6 illustrates a method 600 for parsing a file generated according to the method 300. The method 600 may be performed by the SMO 110 upon receiving the file from the RU 104.

The method 600 includes reading 602 the first line of the file and parsing 604 the column labels from the first line, which further indicates the number of columns. Reading the first line, and each other line of the file, may include reading to an end of line (EOL) symbol.

The method 600 includes reading 606 a next line of the file. The next line is then parsed 608 to obtain the measurement group, parsed 610 to obtain the measurement object, parsed 612 to obtain the start and end time, parsed 614 to obtain the object unit type, and parsed 616 to obtain the object unit identifier.

Remaining values in the next line may be processed by parsing 618 the next value in the line, evaluating 620 whether the value is null, and, if not, storing 622 the value according to the column label associated with the column of the next value. If the value parsed at step 618 is found 624 to be the last value in the line and the end of file (EOF) is found 626 not to have been reached, then processing continues at step 606 with reading of the next line of the file. If the value parsed at step 618 is not the last value in the line, then processing continues at step 618 with parsing of the next value in the line.

The values read according to the method 600 may be stored in a file or object. For example, the values may be stored in an extensible markup language (XML) file according to a schema, JavaScript object notation (JSON) object, or other type of object. In particular, the column labels may be used to determine the data represented by a value and to store the value in a file or object. In particular, values such as the measurement group, measurement object, object unit type, and object unit identifier facilitate generating an object including the data stored in the file for storage and processing by the SMO 110.

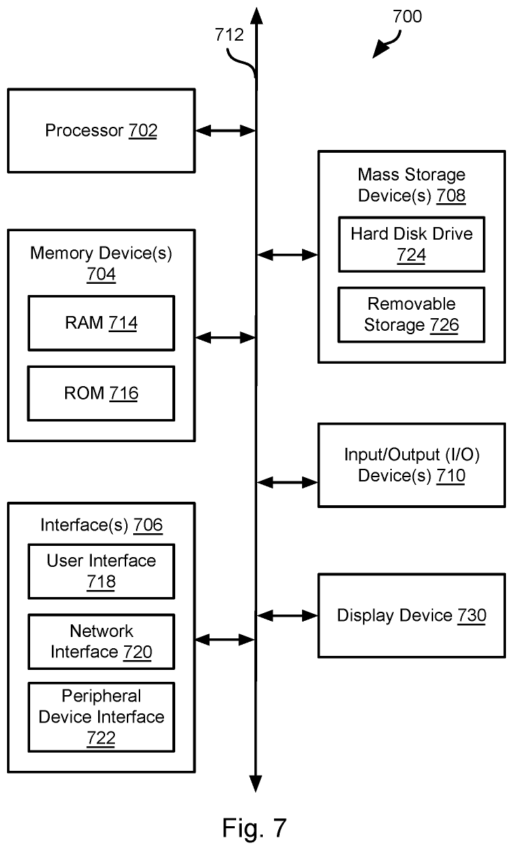

FIG. 7 is a block diagram illustrating an example computing device 700. Computing device 700 may be used to perform various procedures, such as those discussed herein. The nodes 102a-102d and user equipment 116 may have some or all of the attributes of the computing device 700.

Computing device 700 includes one or more processor(s) 702, one or more memory device(s) 704, one or more interface(s) 706, one or more mass storage device(s) 708, one or more Input/output (I/O) device(s) 710, and a display device 730 all of which are coupled to a bus 712. Processor(s) 702 include one or more processors or controllers that execute instructions stored in memory device(s) 704 and/or mass storage device(s) 708. Processor(s) 702 may also include various types of computer-readable media, such as cache memory.

Memory device(s) 704 include various computer-readable media, such as volatile memory (e.g., random access memory (RAM) 714) and/or nonvolatile memory (e.g., read-only memory (ROM) 716). Memory device(s) 704 may also include rewritable ROM, such as Flash memory.

Mass storage device(s) 708 include various computer readable media, such as magnetic tapes, magnetic disks, optical disks, solid-state memory (e.g., Flash memory), and so forth. As shown in FIG. 7, a particular mass storage device is a hard disk drive 724. Various drives may also be included in mass storage device(s) 708 to enable reading from and/or writing to the various computer readable media. Mass storage device(s) 708 include removable media 726 and/or non-removable media.

I/O device(s) 710 include various devices that allow data and/or other information to be input to or retrieved from computing device 700. Example I/O device(s) 710 include cursor control devices, keyboards, keypads, microphones, monitors or other display devices, speakers, printers, network interface cards, modems, lenses, CCDs or other image capture devices, and the like.

Display device 730 includes any type of device capable of displaying information to one or more users of computing device 700. Examples of display device 730 include a monitor, display terminal, video projection device, and the like.

Interface(s) 706 include various interfaces that allow computing device 700 to interact with other systems, devices, or computing environments. Example interface(s) 706 include any number of different network interfaces 720, such as interfaces to local area networks (LANs), wide area networks (WANs), wireless networks, and the Internet. Other interface(s) include user interface 718 and peripheral device interface 722. The interface(s) 706 may also include one or more peripheral interfaces such as interfaces for printers, pointing devices (mice, track pad, etc.), keyboards, and the like.

Bus 712 allows processor(s) 702, memory device(s) 704, interface(s) 706, mass storage device(s) 708, I/O device(s) 710, and display device 730 to communicate with one another, as well as other devices or components coupled to bus 712. Bus 712 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 700, and are executed by processor(s) 702. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

In the above disclosure, reference has been made to the accompanying drawings, which form a part hereof, and in which is shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, an in-dash vehicle computer, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors, and may include hardware logic/electrical circuitry controlled by the computer code. These example devices are provided herein purposes of illustration, and are not intended to be limiting. Embodiments of the present disclosure may be implemented in further types of devices, as would be known to persons skilled in the relevant art(s).

At least some embodiments of the disclosure have been directed to computer program products comprising such logic (e.g., in the form of software) stored on any computer useable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments, but should be defined only in accordance with the following claims and their equivalents. The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

1. A system comprising:
a cellular communication antenna; and
a radio unit (RU) coupled to the cellular communication antenna, the RU configured to:
retrieve status data of the RU;
write a plurality of values of the status data in a file by, for each row of a plurality of rows of the file storing a measurement group and an object unit identifier corresponding to the measurement group, the measurement group and the object unit identifier being assigned to values from the status data stored in each row of the plurality of rows; and
at least one of store the file on the RU or transmit the file.

2. The system of claim 1, wherein the status data describes one or more components of the RU.

3. The system of claim 2, wherein the one or more components include at least one of optical transceiver measurements; transmit window measurements; receive window measurements; energy measurements; power measurements; environment measurements; or received signal strength indicator (RSSI) measurements.

4. The system of claim 1, wherein the status data includes at least one of measurement object, object unit type and report information type where the report information type can be one of min, max, first, latest or frequency bin.

5. The system of claim 1, wherein the RU is configured to, for each row of the plurality of rows, write an object unit type corresponding to the object unit identifier in each row of the plurality of rows.

6. The system of claim 1, wherein the RU is configured to, for each row of the plurality of rows, write a start time and an end time corresponding to the status data stored in each row of the plurality of rows.

7. The system of claim 1, wherein the RU is configured to write, to each row of the plurality of rows, a report information type label and a report information value.

8. The system of claim 1, wherein the RU is configured to transmit the file to a remote orchestrator over a network connection.

9. The system of claim 1, wherein the file stores the status data in a comma separated format.

10. The system of claim 1, wherein the file has a row and column format.

11. The system of claim 10, wherein the row and column format has a fixed number of columns and the RU is configured to write column labels to the file, the column labels labeling columns of the row and column format.

12. The system of claim 10, wherein the row and column format has a fixed number of columns and the RU is configured to write null values to positions in the row and column format for which the status data does not include corresponding information.

13. The system of claim 1, wherein the plurality of rows of the file have a plurality of different numbers of columns, each row of the plurality of rows storing one or more attribute-value pairs.

14. A method comprising:
retrieving, by a radio unit (RU), status data of one or more components of the RU, the RU being coupled to a cellular communication antenna;
writing, by the RU, a plurality of values of the status data in a file by, for each row of a plurality of rows, writing a measurement group and an object unit identifier assigned to values from the status data stored in each row of the plurality of rows; and
at least one of (a) storing, by the RU, the file on the RU or (b) transmitting, by the RU, the file to a remote computing device over a network connection.

15. The method of claim 14, wherein the plurality of rows have a plurality of different numbers of columns.

16. The method of claim 15, wherein each row of the plurality of rows stores one or more attribute-value pairs.

17. The method of claim 14, further comprising writing, by the RU, for each row of the plurality of rows, a measurement object corresponding to the measurement group.

18. The method of claim 17, further comprising, for each row of the plurality of rows, an object unit type corresponding to the object unit identifier stored in each row of the file.

19. A non-transitory computer-readable medium storing executable code that, when executed by one or more processing devices, causes the one or more processing devices to:
retrieve status data of one or more components of a radio unit (RU), the RU being coupled to a cellular communication antenna;
write a plurality of values of the status data in a file by, for each row of a plurality of rows, writing a measurement group and an object unit identifier assigned to values from the status data stored in each row of the plurality of rows; and
at least one of (a) store the file on the RU or (b) transmit the file to a remote computing device over a network connection.

20. The non-transitory computer-readable medium of claim 19, wherein the executable code, when executed by the one or more processing devices, further causes the one or more processing devices to at least one of:
(c) write the file having a row and column format having a fixed number of columns and to write column labels to the file, the column labels labeling columns of the row and column format; or
(d) write the plurality of rows to the file having a plurality of different numbers of columns, each row of the plurality of rows storing one or more attribute-value pairs.
